(19) United States
(12) Patent Application Publication
(10) Pub. No.: US 2011/0056519 A1
(43) Pub. Date: Mar. 10, 2011

(54) Portable Containment Device and Method

(76) Inventors: Tommy Jack Card, Oroville, CA (US); Shana Renee Card, Oroville, CA (US)

(21) Appl. No.: 12/946,726

(22) Filed: Nov. 15, 2010

Related U.S. Application Data
(63) Continuation-in-part of application No. PCT/US2009/049628, filed on Jul. 2, 2009.
(60) Provisional application No. 61/261,302, filed on Nov. 13, 2009.

(51) Int. Cl. B08B 7/00; B65D 33/00

(52) U.S. Cl. 134/10; 220/9.4

(57) ABSTRACT

The present invention provides a containment device comprising a support structure and a container being flexible and removably attached to the support structure. The container has a cavity defined by a base and a plurality of walls. The container has a top perimeter defined by the walls and a bottom perimeter defined by the base, wherein the dimension of the top perimeter is less than the bottom perimeter, and wherein the support structure is substantially disposed within the cavity.

### CROSS REFERENCE TO RELATED APPLICATION

This application is a nonprovisional application of U.S. Provisional Application No. 61/261,302 filed on Nov. 13, 2009 and International Application No. PCT/US2009/049628 filed on Jul. 2, 2009, which claims priority to U.S. Provisional Application No. 61/077,790 filed on Jul. 2, 2008, and this application claims priority to each of these application and each of these applications are incorporated in their entireties herein by reference.

### BACKGROUND OF THE INVENTION

1. Field of Invention

This invention relates to containment devices and more particularly to portable containment devices and concrete washout devices.

2. Description of Related Art

Numerous conventional containment devices exist that provide a means for containing a liquid or solid for construction or industrial type applications. However these conventional devices have numerous shortcomings. There are numerous applications for containment devices; such as for example concrete washout devices, other hazardous waste cleanout devices, temporary water storage for forest fire fighting, and etc.

With regard to cleanout and washout usage of devices, they are primarily used in industrial settings to comply with the increased demands regarding the disposal of hazardous materials from the U.S. Environmental Protection Agency (EPA) and Storm Water Pollution Prevention Plan (SWPPP).

One conventional device is a primitive washout system having hay bales arranged to form a perimeter and a plastic rolled out and placed over the bales. Another conventional device is a metal box style washout. These conventional devices have numerous shortcomings and drawbacks. Particularly, these and other types of conventional devices fail to provide a containment device that is portable, ready-made and easy to setup and use. Further they fail to provide a containment device that is safe for the environment by preventing spillage of hazardous materials and safe for the users of the device, while being cost efficient and easy to maintain. Further conventional devices fail to provide for easy disposal of the material captured by the device.

The disposal of hazardous material, such as concrete, contaminated liquid, or any variation thereof has many potential problems and/or deterrents such as: operators avoid the use of any washout system due to the high cost of a washout system; operators avoid the use of any washout system due to the inconvenience and need to plan ahead in order to obtain a washout system; leaks, spills and blowouts of contaminated material from the washout and onto the ground; injury to operators and/or trucks during the washout process; labor intensive maintenance on washout systems; labor intensive disposal of washout is labor intensive, inconvenient and costly or the operator neglects to dispose of the washout leaving it to further contaminate the environment.

Operators tend to avoid the use of any conventional washout systems due to the high cost of existing washout systems. The most primitive conventional washout system requires the operator to purchase and transport at least eight hay bales and a roll of plastic. The metal box style conventional washouts require the operator to rent the washout for a costly daily fee; maintenance fee; removal of contamination fee; and delivery and pick up of metal box fee.

Operators also tend to avoid the use of any of the conventional washout systems due to the inconvenience and need to plan ahead in order to obtain a washout system. A ready-made, easy to use washout system is currently not available. A plan must be thought out in advance to obtain hay bales and plastic; install and configure the washout; and prepare for the disposal of concrete; contaminated sediment or liquid; or any variation thereof. If the metal box washout is preferred, a call to a local distributor that is hopefully nearby will deliver the metal box anywhere from the next day to seven days after the request. Projects in need of the metal washout are often out of the area of distributors and either cannot be delivered; a delay in delivery occurs; or the cost is dramatically increased for out of the area delivery.

Further, leaks, spills and blowouts of contaminated material from the washout and onto the ground occurs almost every time the hay bales and plastic are used. The plastic has a high probability of puncture holes and tears as the concrete; contaminated sediment or liquid; or any variation thereof is dumped onto it. Also as the contaminated material is dumped onto the plastic, the plastic becomes heavy and often departs from the hay bales allowing blow outs and spillage onto the ground.

Injury to operators and/or trucks during the washout process is also common with conventional metal box type containment devices/washouts. Injury to the operator often occurs while attempting to balance on the top edge of the wet metal box during the process of reaching to spray a water hose into the concrete truck; loader or any variation thereof. Damage to the concrete truck occurs when it is backed up onto the metal box ramps and driver error slips a tire off the ramp. This results in the entire truck rolling over on its side and onto the ground. In this instance, injury to the driver is highly probable and those in the surrounding area are also subject to injury.

Conventional washouts generally also have labor intensive maintenance process. During the process of washing out concrete, contaminated sediment or liquid, or any variation thereof into the hay bale formation requires an operator to stand by watching for any leaks or blow outs onto the ground. If any contamination is detected on the ground all washout performance must stop until the hay bales and plastic are realigned to resume again. This process is not uncommon to occur multiple times during one washout of a concrete truck. The metal boxes also require labor intensive maintenance during the washout process. As the operator must have another person on the ground guiding the truck up on the ramps in order to perform the washout process.

Disposal of the washout is also labor intensive, inconvenient and costly or even sometimes the operator neglects to dispose of the washout at all leaving it on site permanently. Hay bale washouts are often found on construction sites years after the construction was performed. This is not only unsightly to see mildewed rotten hay bales but it is also continuing to pollute the environment with the abandoned contaminated material left inside. If the operator does choose to dispose of the hay bales, they must be hauled away to a landfill along with the ripped plastic and mounds of dried concrete; contaminated sediment or liquid; or any variation thereof. This disposal procedure costs many labor hours, dump fees and is inconvenient. The metal box is also labor intensive while disposing of contaminated material, as a pump or dump truck must remove the material out of the metal box and then the operator calls the metal box distributor to pick up the box. The metal box is expensive to rent and expensive to dispose of the waste material because they must call a pump or dump truck for assistance. This method is also very inconvenient and labor intensive.

### SUMMARY OF INVENTION

It is the object of the present invention to overcome the drawbacks and shortcomings of conventional containment devices. This present invention provides a containment device that is portable; ready-made; easy to transport and setup; safe for the environment and the users and equipment; cost efficient requiring low maintenance; and allows for easy and efficient disposal of materials contained by the containment device.

The present invention provides a containment device comprising a support structure and a container being flexible and removably attached to the support structure. The container has a cavity defined by a base and a plurality of walls. The container has a top perimeter defined by the walls and a bottom perimeter defined by the base, wherein the dimension of the top perimeter is less than the bottom perimeter, and wherein the support structure is substantially disposed within the cavity.

The present invention further provides a containment device wherein the support structure includes a plurality of support members removably attached to at least one of another of the plurality of members. Still further the invention provides a devices wherein the support structure includes a plurality of interconnected first and second supports and the container includes at least one sleeve disposed along the top perimeter, wherein the first supports are disposed within the cavity and the second supports engage the container and extend through the at least one sleeve. Yet further, in some embodiments, the support structure of the containment device includes a base support disposed at an end of each of the first supports. Further, in other embodiments, the walls of the container of the containment device are non vertical. Still in other embodiments of the present invention a container of the containment device includes at least two straps disposed on an underside of the cavity of the container. Additional embodiments of a containment device further include a cover being removably attached to the support structure and operably configured to cover the cavity when in use. Additional embodiments may also include a filter removably attached to the support structure and at least partially disposed within the cavity of the container. In some of the exemplary embodiments the filter has a filter top perimeter and a plurality of hoisting straps disposed adjacent to the liner top perimeter.

The present invention also provides a containment device comprising: a framework having a plurality of horizontal poles and a plurality of vertical poles, each of the vertical poles being connected to at least two of the plurality of the horizontal poles; and, a container being flexible and having a base and a plurality of walls, the base being connected to a bottom edge of each of the walls and each of the walls being connected to another one of the walls defining a cavity of the container, wherein the cavity has a top perimeter and at least one sleeve disposed along the top perimeter and wherein at least one of the horizontal poles of the framework is disposed within the at least one sleeve and the vertical poles of the framework are disposed within the cavity.

The present invention further provides a containment device wherein the connection between the plurality of vertical poles and horizontal poles includes a removable connection. Still further, in some exemplary embodiments each of the plurality of walls is disposed at an angle of less than 90 degrees relative to the interior bottom of the cavity. Yet further, a containment device is provided wherein the container includes at least two straps disposed on at least portions of two opposing walls of the plurality of walls. In some other exemplary embodiments, the plurality of walls and base are integral and the plurality of walls form a continuous wall. In other exemplary embodiments containment devices of the present invention include a cover that is removably attached to the framework and operably configured to cover the cavity when in use. Still further, some exemplary embodiments of the containment device include a liner removably attached to the framework and at least partially disposed within the cavity of the container. In some of those embodiments, the liner is a permeable mesh filter. Further, in some exemplary embodiments, the liner includes a liner top perimeter and plurality of straps disposed adjacent to the liner top perimeter.

The present invention also provides a containment washout method comprising: an installation step including assembling a support structure and securing a flexible container having walls to the support structure with the support structure being substantially disposed within the container and with the walls being attached to the support structure in a non-vertical alignment; a washout step including orienting the equipment device to be washed out with and over one of the walls of the container and washing the equipment with a liquid such that the liquid and material being washed out of the equipment fall in the container; and, a disposal step includes removing the support structure and collapsing up the walls of the container. In other exemplary embodiments, the installation step includes attaching a filter to the support structure such that the filter is substantially disposed within the container. Still further in other exemplary embodiments, the disposal step includes hoisting the filter from the container.

It is an objective of the present invention to provide a portable containment system that is adaptable for use in a variety of applications, industries and usages, such as use as a concrete washout system, a portable water storage for forest fire fighting purposes, a portable storage for contaminated liquids and sediments, an oil or lube bay, or even use as any containment needs for a farmer or homeowner, and the like.

An objective of one embodiment of a containment device of the present invention is to provide an environmentally safe and sanitary way to dispose of cement; contaminated sediment or liquid; or any variation thereof. The secure structure of the present invention prevents potential spills onto the ground and into clear waterways. The present invention provides an enclosure for an environmentally safe and sanitary way of disposal avoiding the use of hay bales and plastic containment areas which leak and must be built on site.

The present invention provides in one exemplary embodiment, a containment device having a container made of vinyl, which unlike hay bales and plastic or metal containment systems, has strong yet lightweight walls to prevent potential spills of contamination onto the surrounding ground area as concrete; contaminated sediment or liquid; or any variation thereof is poured into the container via cement truck, loader or any variation thereof.

The present invention also reduces operator injury during set up of the containment device by utilizing a lightweight container that is easy to transport to the site location and is easily installed within minutes. This is in stark contrast to conventional devices with may require the dragging of hay bales into a square formation and draping large rolls of plastic across the top of the hay bales to create a containment structure, or the hassle and inconvenience of having to have a prefabricated containment box shipped and installed at a location, which will generally require large equipment to transport and install.

In accordance with a method of the present invention, an operator uses inserts to support framework into the pockets or sleeves of the container, and then inserts anchor stakes through the anchor loops on all four corners of the container securing the container to the ground and the containment device is installed and ready for use. With such an easy and efficient set-up process, operators have drastically minimized the potential for bodily injury as compared to conventional devices.

The present invention also does not require narrow metal ramps in order to utilize the containment system as is often required with conventional metal containment or washout devices. With conventional metal containment devices that require the ramps, if a driver's tire slips off the ramp the truck will roll over onto its side on the ground. These mishaps are avoided with the present invention since the present invention provides an embodiment wherein the containment device is anchored directly to the ground and allows trucks to stay firmly on the ground to use the container.

Another advantage of the present invention is the disposal of the materials contained by the containment device. The present invention provides for easy disposal after use, by allowing the container to be simply rolled up and thrown away once all the liquid has evaporated in the container. In contrast conventional devices require such things as hauling off mildewed hay bales, which is labor intensive and can cause contamination. During the dumping process the plastic is almost always punctured, ripped and torn allowing leaks onto the ground and into our clear water ways. After this contaminated material has hardened the operator has a pile of partial pieces of plastic and a pile of hardened concrete to dispose of without it touching the ground. This is virtually impossible. With regard to conventional metal containers the operator must tow the container off the site and take it to a dump or landfill to rid of the concrete contents. Again this is time consuming, labor intensive and expensive, which is in stark contrast to the easy and cost efficient disposal provided by the methods and structure of the present invention.

An advantage of the present invention is the convenient size and ease of setting up various embodiments of the containment devices made in accordance with the present invention. The present invention provides some embodiments of the containment device that have disassembly of the supporting framework and rolling-up or folding of the container, which enables a user to conveniently store the device without consuming a significant amount of space, such as in a truck. This allows a concrete truck operator to conveniently store a concrete washout device made in accordance with the present invention for example in a truck at all times. Further, with the present invention, one operator can easily set up the containment device of the present invention in minutes without any help. Conventional devices such as hay bales and metal containers are not this portable and the set up for these systems is time consuming and requires more than one person.

These and other features and advantages of this invention are described in, or are apparent from, the following detailed description of various exemplary embodiments of the devices and methods according to this invention.

### BRIEF DESCRIPTION OF THE DRAWINGS

Various exemplary embodiment of this invention will be described in detail, with reference to the following figures, wherein;

FIG. 1 is a perspective view of a containment device made in accordance with the present invention;

FIG. 2 is a perspective view of an alternative embodiment of a containment device made in accordance with the present invention;

FIG. 3 is an enlarged perspective view of a portion of the containment device of FIG. 2, take along circle 3-3;

FIG. 4 is a partial perspective view of the containment device of FIG. 2, shown with a filter of the containment device in the process of being hoisted away from the remainder of the containment system;

FIG. 5 is a cross-sectional view of a portion of the containment device taken along line 5-5 in FIG. 2;

FIG. 6 is a bottom perspective view of the containment device of FIG. 2;

FIG. 7 is a perspective view of the containment device of FIG. 2, shown with a container member of the containment device in the process of being hoisted; and,

FIG. 8 is a perspective view of an alternative embodiment of a containment device made in accordance with the present invention.

### DETAILED DESCRIPTION OF THE PREFERRED EMBODIMENTS

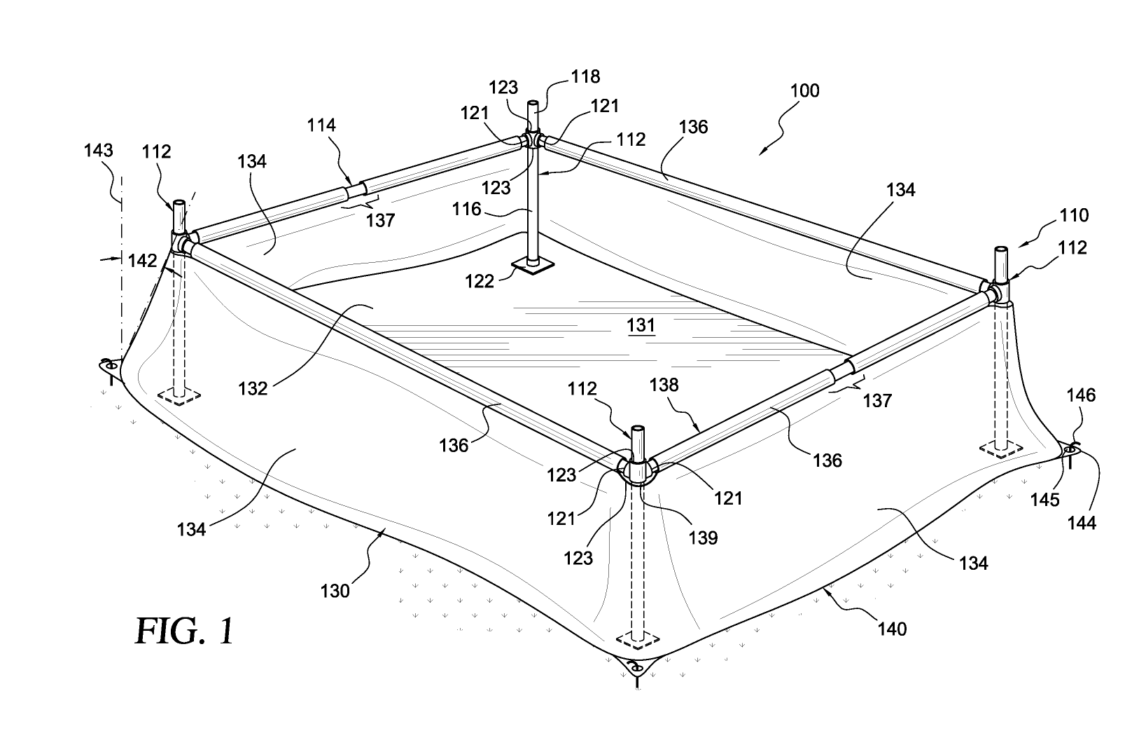

FIG. 1 shows a containment device 100, made in accordance with this invention. The device 100 is designed to be operably configured to provide a portable containment device. A device made in accordance with the present invention can be utilized to contain contaminated or non-contaminated material and/or liquid. There are thousands of potential uses for a device made in accordance with the present invention, all of which are not set forth individually herein, but which will be understood and appreciated by the review of the description and figures herein.

The device 100 includes a support structure 110 and a container 130. The support structure 110 engages the container 130. The support structure 110 supports the container such that the container 130 defines a cavity 131 and is operably configured to receive and contain materials, such as liquids and/or solids. In this exemplary embodiment the container 130 has an open top to facilitate the depositing of materials in the container.

The cavity 131 has an upper perimeter 138 and a base perimeter 140. The upper perimeter 138 defines the opening of the cavity 131. The support structure 110 in this exemplary embodiment is substantially disposed within the upper perimeter 138. It is further preferred that the support structure 110 be disposed at or adjacent to the upper perimeter 138. It should be appreciated that in other exemplary embodiments the support structure is dispose beyond the upper perimeter 138.

The support structure 110 includes first and second supports 112 and 114. The first and second supports are preferably made of PVC (polyvinyl chloride). Further, in this exemplary embodiment, the first and second supports 112 and 114 are made from conventional PVC plumbing components. It should be appreciated that other materials may be utilized. The material employed should provide some rigidity, but also be lightweight. PVC plumbing components offer these advantages, as well as being inexpensive and easily attachable and removable from one another. The first supports 112 are removably attached to the second supports 114. Having the first and second supports 112 and 114 removably attachable to each other enhances the portability of the containment device 100. It should be appreciated that in other exemplary embodiments the first and second supports are integral or unitary members. In such embodiments, the portability of the containment device will be generally lessened. It should be further appreciated that the first and second supports in other exemplary embodiments may be collapsible such that the components of the structure fold-up upon one another similar to conventional elastic cord linked tent poles.

The support structure 110 preferably includes four first supports 112. At least one of the first supports 112 preferably includes a primary member or leg 116, an attachment member or upright 118 and a connecting member 120. In this exemplary embodiment, each of the first supports includes the features 116, 118 and 120. The first supports 112 are preferably substantially vertical when in use and the second supports 114 are preferably in a horizontal arrangement when in use. The primary member 116 of each of the first supports 112 is disposed within the cavity 131. It should be appreciated that in other exemplary embodiments the leg 116 and the attachment member 118 is a single unitary member that extends through the connection member.

The connecting member 120 includes receptacles 121 positioned 90 degrees apart on the same plane. The receptacles 121 receive the second supports 114. The second supports are removably inserted into the receptacles. The engagement is a snug fit wherein a user can remove the members by pulling them apart when desired. The connecting member 120 further includes receptacles 123 positioned 90 degrees apart on the same plane and 90 apart relative to the plane of the receptacles 121. The receptacles 123 removably receive the primary member 116 and the attachment member 118. This engagement is a snug fit wherein a user can remove the members by pulling them apart when desired. The attachment members 118 are optional for this exemplary embodiment.

The second supports 114 are arranged and engaged with the first supports 112 to form the support structure 110. The support structure 110 provides a framework for the container 130, which in this exemplary embodiment attaches to the second support members 114. In this exemplary embodiment, the first and second supports 112 and 114 are attached to form a generally square frame. It should be appreciated that in other exemplary embodiments other shapes are formed, such as but not limited to pentagons, ellipses, circles, octagons, and the like.

In this exemplary embodiment, each of the first supports 112 further includes a base member 122. The base member 122 is disposed at an end of the primary member 116. It is disposed at the opposing end from the end that engages the connecting member 120. The base member 122, when in use, rests on the container within the cavity. The base member 122 provides further overall stability to the support structure 110. It should be appreciated that the base members 122 are optional and the support structure 110 can effectively function without the base member 122.

The container 130 engages the support structure 110. The container is preferably made from a flexible but strong material, such as but not limited to vinyl. The preferred material for the container 130 is vinyl as it is strong, but yet lightweight. The flexibility of the container 130 allows it to be rolled up or folded easily when it is removed from the support structure 110, enhancing the portability of the device. The container 130 is configured to received liquids and/or solids within the cavity 131.

The container 130 includes a base 132 and at least one wall 134. It is preferred that the base 132 and the wall 134 be completely integral and made from a single piece of material. It should be appreciated that these components may, in other exemplary embodiments be made from separate components or pieces but yet attached together to form a unitary or integral piece. It should be appreciated that the wall can be made of one continuous wall or a plurality of walls joined together. Further, it should be appreciated that the container can have many various shapes, such as a rectangular shape, circular shape, etc.

In this exemplary embodiment the container 130 includes four walls or sections 134 which are each connected to one another and the base 132. The base 132 and the walls 134 define the cavity 131. Each one of the plurality of walls 134 preferably includes engagement sleeves or pockets 136. The engagement sleeves 136 are disposed on the respective wall 134. Preferably, an engagement sleeve 136 is disposed along at least a portion of the top edge of the respective wall. The top edge of the plurality of walls 134 defines a first perimeter of the container 130. This first perimeter defines the opening of the cavity 131. It is preferred that the engagement sleeves 136 be disposed along portions of the walls 134 along the first perimeter 138. The engagement sleeves 136 in this exemplary embodiment are extensions of the walls 134. The wall material extends up and is folded upon itself and attached to the wall so as to form a sleeve. The walls 134 are attached to the support structure 110 via the sleeves 136. Individual second supports 114 of the support structure 110, when the device 100 is assembled, are disposed within respective sleeves 136. With this arrangement, the walls 134 hang from the second supports 114 of the support structure 110.

In this exemplary embodiments the engagement sleeves 136 do not extend completely around the first perimeter 138. Rather each wall 134 includes sleeves 136 extend only along a portion of its top edge. The engagement sleeves 136 have breaks 137 and 139 along each wall 134. The breaks 137 are preferably disposed near the midway point along the top edge of some of the walls. These breaks 137 facilitate and enhance the folding of the container prior to use and during the disposal process. The breaks 139 are disposed at the ends of each of the respective walls 134. The breaks 139 enable the connecting member 118 of the support structure 110 to be exposed to the user facilitating the rapid and easy set-up and assembly of the components of the device 100.

The bottom edges of the walls 134 join the base 132. This juncture defines a second perimeter 140 of the container 130. The second perimeter 140 is preferably larger in dimension than the dimension of the first perimeter 138. This larger dimension provides the container with an overall hollow pyramidal frustum shape. The top of the opening of the container (perimeter 138) is preferred to have a generally rectangular shape. It should be appreciated that in other exemplary embodiments, the shape of the perimeter 138 and/or the perimeter 148 is other shapes, such as but not limited to square, circular, elliptical, etc. The dimension offset or difference between the second and first perimeters is preferred to be a ratio of about 2:1 (perimeter 140:perimeter 138). In another exemplary embodiment, the dimension offset or difference between the second and first perimeters is preferred to be a ration of about 2:0.5. It should be appreciated that in other embodiments, other or varying ratios may be utilized. It is preferred to have the walls of the container not be completely vertical, but rather at least slightly inclined from the second perimeter to the first lesser dimensioned first perimeter. The strength and stability of the walls are increased with such an arrangement.

At least one of the walls 134 is preferable disposed at an angle of less than 90 degrees relative to the interior bottom of the cavity. The dimensional difference between the first and second perimeters 138 and 140 enable the walls 134 of the container to be sloped at an angle 142 relative to a vertical axis 143. The angle 142 is preferred to be greater than zero. Then angle 142 is preferred to be of a value that enables the walls to non-vertical. The angle 142 is preferred to less than about seventy degrees. The angle 142 makes the walls of the device sloped inward toward the opening of the container. The sloped walls 134, as indicated above, enhance the stability and strength of the containment device 100. In use, as the cavity fills with a material, the material, such as a liquid, will be forced against the interior of the inclined walls and the base thereby creating a wedging effect. This wedging effect will strengthen the wall and the containment devices ability to hold more material.

The container 130 further includes securing members 144. The securing members 144 are preferably disposed at various positions along the junction of the walls 134 and the base at the bottom of the walls 134. In this embodiment the securing members 144 are disposed at the four corners of the container 130. The securing members are preferably vinyl pieces of material that extend away from the container. The securing members 144 include an opening 145. It should be appreciated that in other exemplary embodiments the securing members are other types of securing means, such as d-rings, metal rings, clamps, tethers and the like. A fastener 146 is preferably disposed through the opening 145 and into the surrounding material that the containment device 100 is resting upon, such as the ground. The fastener 146 is preferably a stake made of metal or plastic. It should be appreciated that the securing members may be secured to the ground via other fasteners and methods, such as with rope, chains and the like. With the securing members 144 pulled-out away from the device 100, when in use, will facilitate the filling a stability of the device 100.

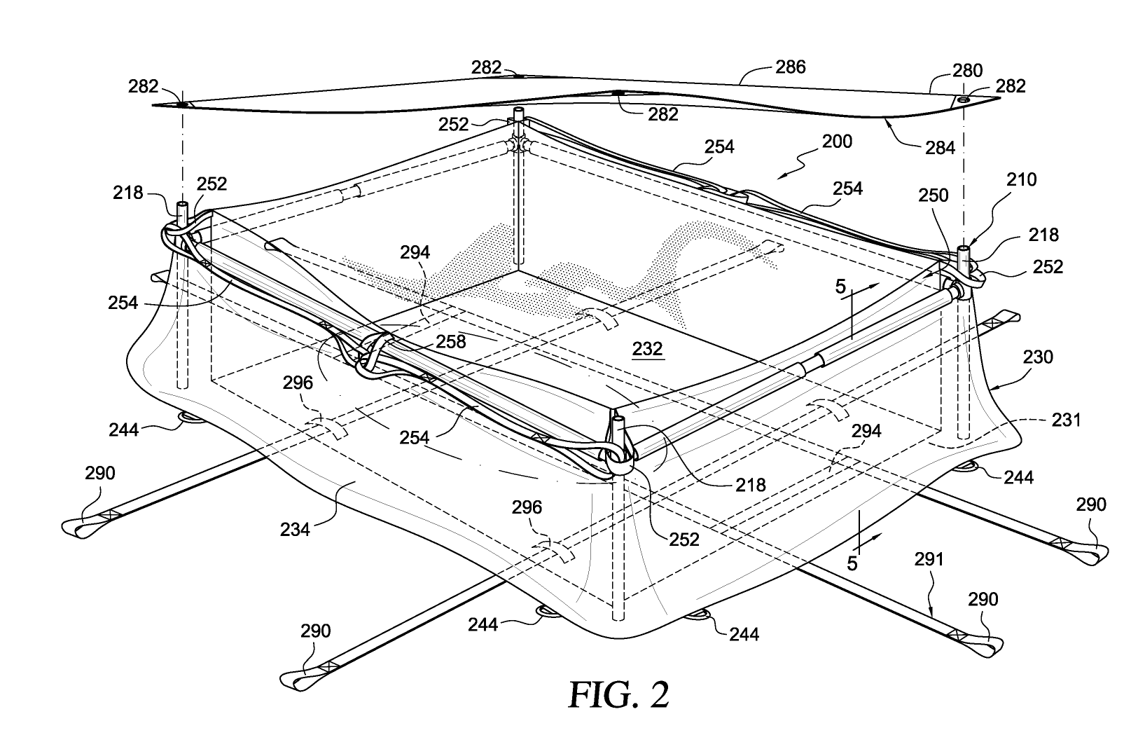

Referring now to FIGS. 2-7, a containment device 200 is shown, which is an alternative embodiment of a containment device made in accordance with the present invention. The device 200 incorporates all of the characteristics and features of the device 100 referenced above. Particularly, the device 200 includes a support structure 210 and a container 230, with each of their respective components and features as mentioned above for device 100. For clarity when similar components are referenced below in connection with device 200, similar and corresponding reference numbers will be used.

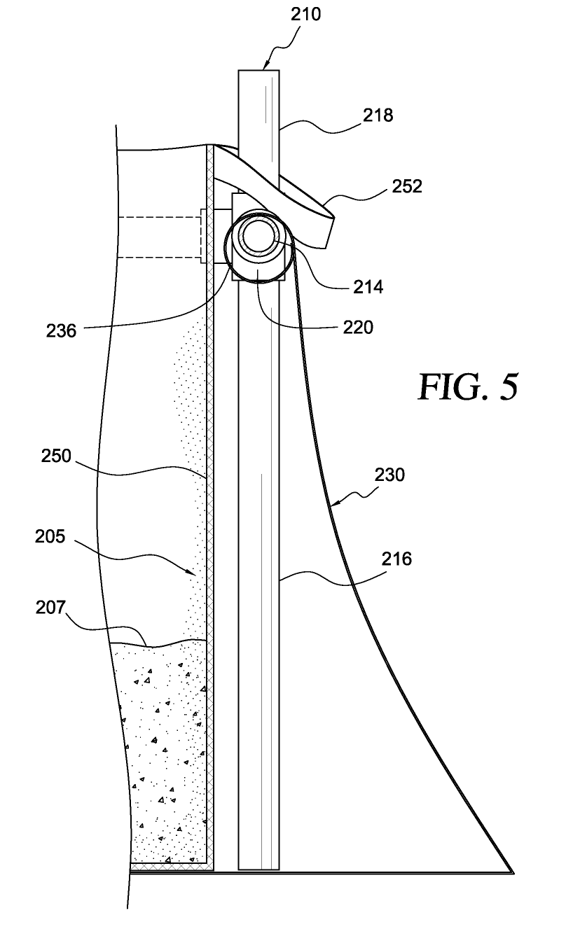

A difference between containment device 200 and containment device 100 is that containment device 200 includes a liner 250. The liner 250 is disposed substantially within the cavity 231 of the container 230, as shown in FIGS. 2-5 and particularly FIG. 5. The liner 250 is operably configured to act as a filter when it is lifted out from the cavity 231 to enable the removal of solids 205 from the device while leaving any liquids 207 within the cavity 231 (FIG. 5) as is discussed further herein. The liner is preferably made of a nylon mesh. The sizing of the mesh will depend upon size of the aggregate or solids that are desired to be removed for a particular application. The sizing of the mesh will depend upon the application or use for the device and the sizing will vary to allow a variety of liquid consistencies to permeate through the filter bag or mesh. The sizes can vary from an extremely tight weave to a very large weave, such as half-inch weave, or even greater. The sizing will be application dependent. Also, it should be appreciated that the liner is optional in some applications or uses. The liner 250 preferable has a shape allows for easy and efficient insertion within the cavity. In this exemplary embodiment the shape of the liner is generally that of a box open at the top. It should be appreciated the other shapes may be utilized.

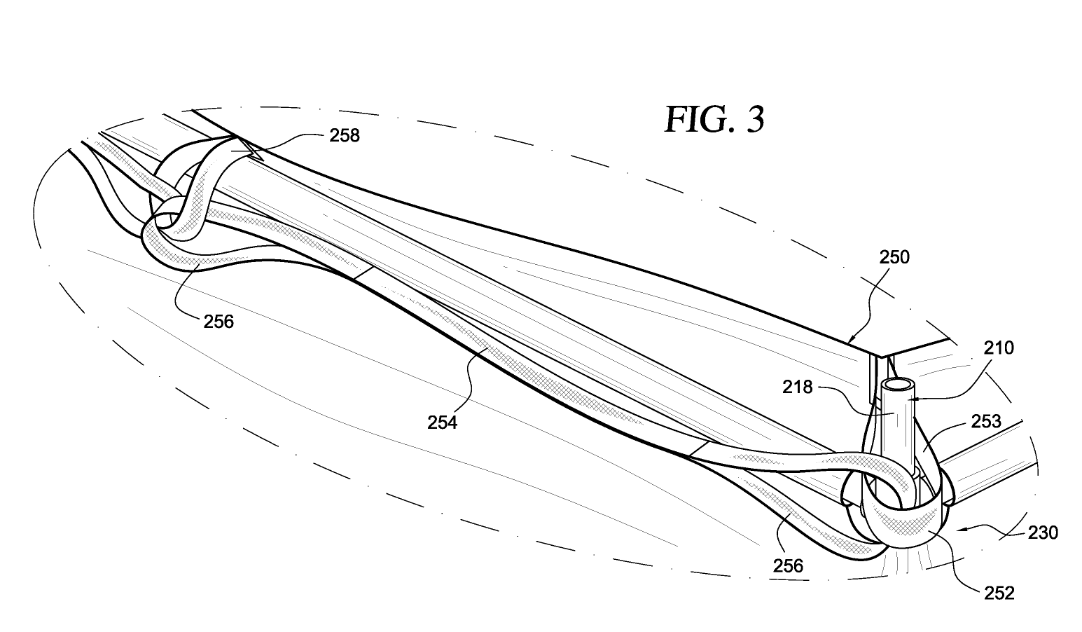

The liner 250 includes a plurality of securing members 252 attached to the liner 250. The securing members have openings 253. When the liner is in use within the cavity 231, the securing members 252 are removably attached to the support structure 210 by having the attachment member 218 of the support structure 210 engage or extend through the opening 253 of the securing members 252 as shown in FIG. 3. This securing member 252 in this exemplary embodiment are preferably strips of material that form loops that are operably configured to be placed over the attachment members 218 of the support structure 210. It should be appreciated in other exemplary embodiments, the securing members are other attachment means, such as but not limited to metal rings, d-rings, corded-loops, chains and the like. In the exemplary embodiment shown in FIGS. 2-7, the liner 250 includes four securing members 252, one disposed at each corner of the liner 250, as shown in FIG. 3.

The liner 250 is configured with hoisting members 254. The hoisting members 254 are preferably made of nylon, but other materials may be utilized. It is further preferred that the hoisting members 254 be nylon straps. In this exemplary embodiment, there are four hoisting members 254 disposed along opposing sides of the liner 250. It should be appreciated that more or less hoisting members may be utilized in other exemplary embodiments and may be disposed along all the sides of liner 250. Each hoisting member includes an attachment loop 256 at each of its opposing ends. One of the attachment loops 256 engages the securing member 252 as shown in FIG. 3. The respective loops of the loop 256 and the member 252 are inter-looped to provide a secure connection and easy relative movement within the bounds of the loops. The other of the attachment loops of the hoisting member 254 is attached to a support loop 258, which is preferably disposed at about a midway location of one of the sides of the liner 250, as shown in FIGS. 2 and 3. The respective loops of the loop 258 and the member 254 are inter-looped to provide a secure connection and easy relative movement within the bounds of the loops.

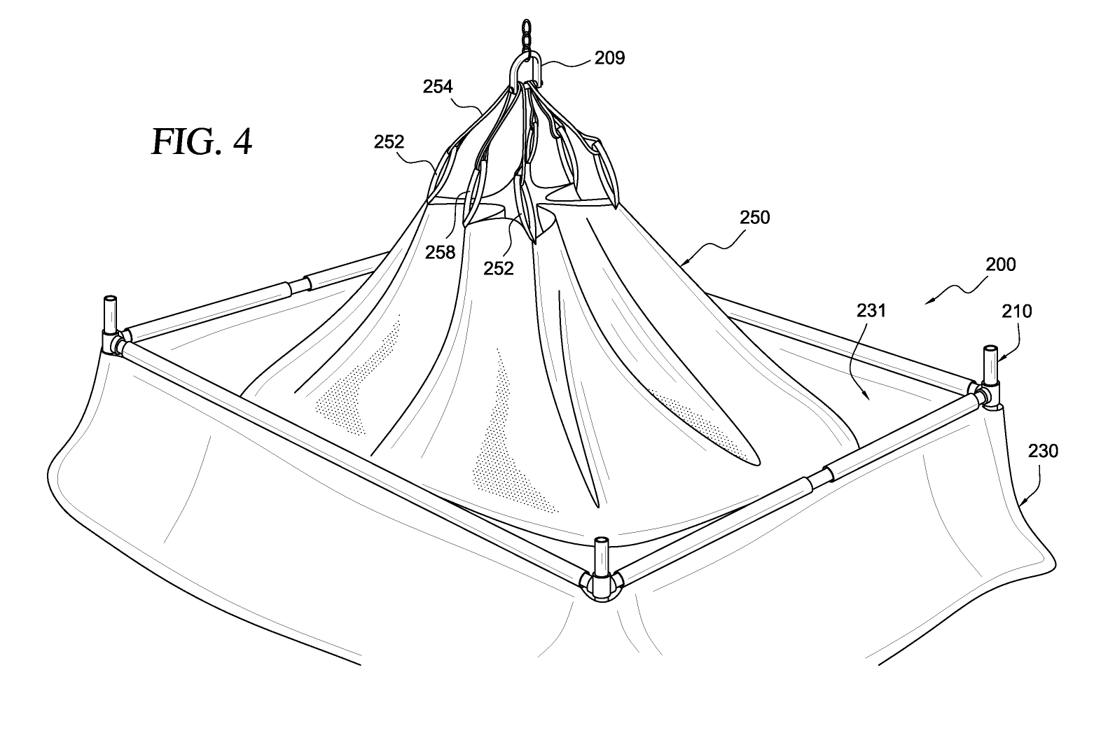

FIG. 4 illustrates the hoisting or lifting of the liner 250 away from the container 230. The hoisting members 254 are attachable to a hoisting link device 209, which is any conventional hoisting mechanism. As the liner 250 is hoisted away from the container 230, any liquid 207 within the container will remain in the cavity 231, while the desired solids will be captured by the liner 250 and removed from the cavity 231. The user can then properly dispose of the solids and subsequently hoist the remainder of the container away using straps 290 to dispose of the remaining liquid. The straps 290 are discussed further below.

Another difference between containment device 100 and containment device 200 is that the containment device 200 includes a cover 280. The cover 280 when used, is utilized to provide a cover over the device 200. The cover 280 includes eyelets 282, which the attachment members 218 of the support structure are configured to extend through so as to support the cover over the container and support structure. In this exemplary embodiment, the perimeter 284 of the cover 280 is bound with an elastic band 286. The band 286 is preferably directly attached to the cover 280. With the perimeter being elastic it enhances the securing of the cover 280 over the container.

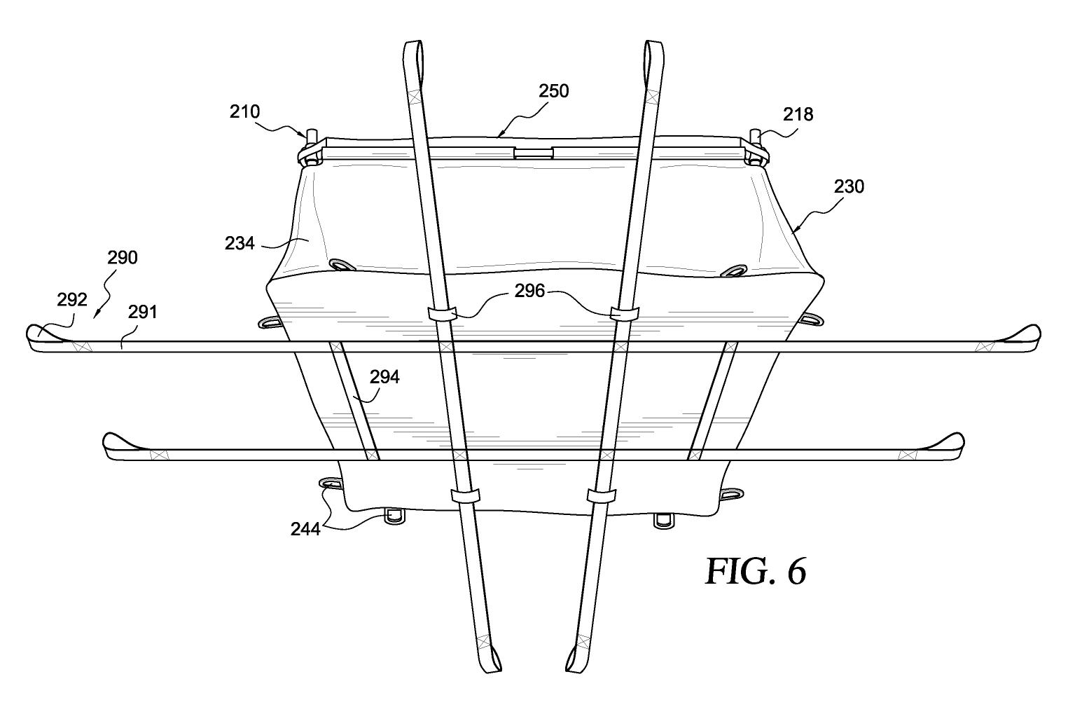

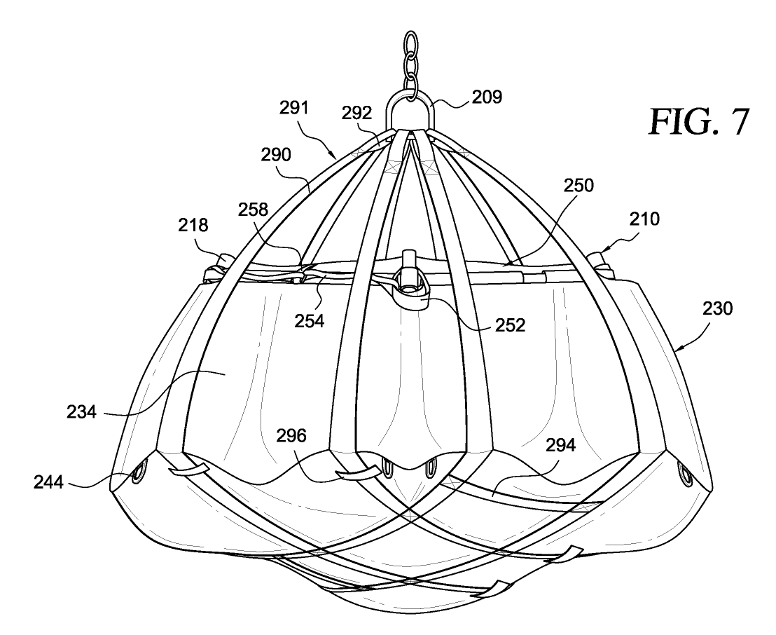

Another difference between containment device 100 and containment device 200 is that the container includes straps 290. The straps 290 are attached to the bottom of the base 232 of the container 230 and extend out from the walls 234, as shown in FIGS. 2 and 6. The straps in this exemplary embodiment are made of nylon and are preferably sewn to the bottom or underside of the base 232. The straps 290 are configured to enable the hoisting and/transportation of the container 230 when the user is ready to dispose of any materials in the container 230. To hoist the container, that terminal ends 291 of the straps are collected together above the container and any conventional hoisting means is attached to each of straps through eyelets 292 provided at the ends 291 of each of the straps 290. The straps 290 are preferably spaced apart from one another and are provided in multiple alignments with the container to provide adequate lifting support for the container. In this exemplary embodiment four straps are provided two arranged in a parallel first alignment and the other two being parallel in a second alignment, wherein the first and second alignments are about 90 degrees apart relative to each other. It should be appreciated that more or less may be utilized in other exemplary embodiments. Lateral straps 294 are also provided. The lateral straps 294 are attached to the bottom of the base 232 and to at least two of the straps 290. The lateral straps enhance the overall stability of the container when the container is being hoisted and/or transported by the straps 290, as shown in FIG. 7. The lateral straps 294 are optional. Further the container includes guides 296 which are attached to the bottom of the base 232. The guides are provided adjacent to various locations of the base where there are unattached portions of the straps 290. The straps 290 extend through the guides 296 and the guides enhance maintaining the alignment direction of the straps. The guides 296 are optional.

Another difference between containment device 100 and containment device 200 is the securing members of the container. In the embodiment of the containment device 200 the securing members 244 are D-rings secured to the container 230 at non-corner locations, rather than straps as showing in the prior embodiment for device 100. Still a further difference is that device 200 does not include the base member as part of the support structure 210 as device 100 has base members 122.

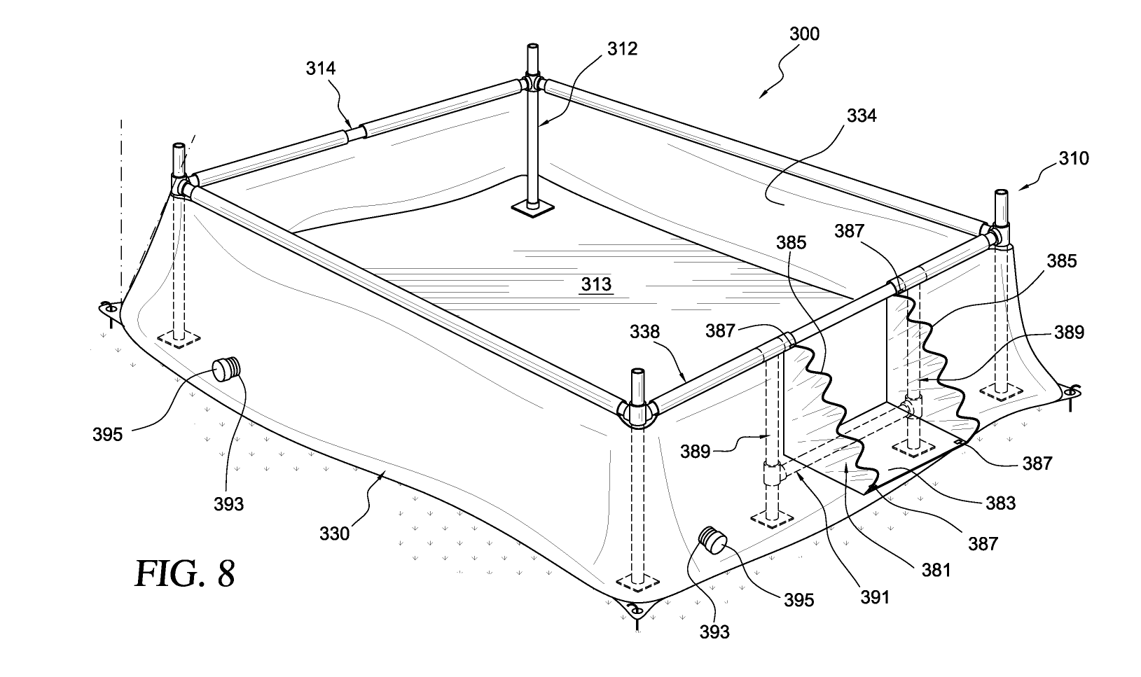

Referring now to FIG. 8, a containment device 300 is shown, which is an alternative embodiment of a containment device made in accordance with the present invention. The device 300 incorporates all of the characteristics and features of the device 100 referenced above. Particularly, the device 300 includes a support structure 310 and a container 330, with each of their respective components and features as mentioned above for device 100, such as for example first and second supports 312 and 314, cavity 331 and first perimeter 338. For clarity when similar components are referenced below in connection with device 300, similar and corresponding reference numbers will be used.

A difference between containment device 300 and containment device 100 is that containment device 300 includes a chute 381. The chute 381 is a portion of the wall 334 that folds away from the remainder of the wall. The chute 381 provides improved access to the cavity 331 of the container 330 for larger vehicles and the like. The chute 381 includes a wall portion 383 and side baffles 385. The side baffles 385 connect the wall portion 383 to the wall 334. The baffles 385 are configured to be arranged in an accordion type manner to enable the wall portion 383 to fold away from and back-to the wall 334. The wall portion 383 extends to the first perimeter 338. However, it should be appreciated that the wall portion 383 may in other exemplary embodiments be a cut-out from the wall, basically an orifice in the wall wherein the cut out portion is the wall portion. At least one fastener 387 is affixed to the wall portion 383 and the wall 334 to selectively hold the wall portion 383 close to the wall 334 when the user desires to have the chute 381 in a closed position. In this embodiment, there are multiple fasteners. The fasteners 387 can be any type of releasable fastener or fastener systems, such as but not limited to snaps, d-rings and clips, zippers, eyelets and rope, etc. While the chute 381 is in the closed position, the baffles 385 keep the container in a sealed state so that anything in the container does not leak out from the chute 381. It should be appreciated that the size and shape of the chute may change depending upon the application.

Another difference between containment device 100 and containment device 300 is the additional support members 389 and 391. These support members are very similar to member 312 and 314 and include similar features. The members 389 and 391 interconnect to provide additional support for the container 330. The support member 389 and 391 are optional. The support members 389 and 391 interconnect preferably near the chute 381. The members 389 connect with the member 314 to be linked with the entire support of the device.

Another difference between containment device 100 and containment device 300 is the addition of a drain 393 and a plug 395. The drain 393 is an orifice in the container 330 that provides fluid access from the exterior of the device 300 to the cavity 331. The drain 393 is preferably located on the wall 334 adjacent the bottom of the container 330. This allows for ease of draining fluid out of the container. The drain 393 is preferably threaded. Being threaded will enable the attachment of other connection devices, such as pumps, hoses, the plug 395 and the like. The plug 395 is operably configured to sealably engage the drain 393. The plug 395 is preferably threaded to provide additional sealing of the drain.

The present invention provides a method of operation of a washout containment device. Any of the above embodiments of the containment device of the present invention may be utilized. The method includes an installation step, a washout step and a disposal step.

The installation or assembly step includes assembling the support structure and securing the container to the support structure via the sleeves as discussed herein. The support structure when assembled is substantially disposed in the cavity of the container. This feature enhances the safety and structure of the device since trucks will be less likely to run into the structure/framework as the base of the container has a greater dimension (as to width and length) than the structure and the perimeter of the top of the container. The installation in some instances the optional step of driving fasteners (anchor stakes) through the securing members of the container (anchor stake loops) into the ground while stretching the container base (floor) to full dimensional capacity. At this point the walls of the container are slightly inclined and the device forms the shape of a frustum pyramid and is ready to hold material. The installation method further includes the optional step of disposing a liner within the cavity of the container and attaching the liner to the support structure.

The washout step includes orienting or facing the equipment to be washed out with and over any wall of the containment device assembled in the prior step, and washing out the contaminated material with water, or another liquid, (usually with a water hose) onto the base of the container. The walls act as a barrier to any over spray of the contaminated material. The support structure or framework provides a stout support system for the vinyl container as the walls prevent any spills onto the ground. The securing members (anchor loops) of the container and the fasteners (anchor stakes) provide stability of the container from slipping on the ground as the washout process occurs.

The disposal step includes removing the support structure or framework and folding up the walls of the container. Depending on the size of the washout material dried on the base of the container, it can be picked up by either a couple of men, a loader bucket, or the straps on the bottom may be utilized to hoist the container and taken to a dumpster on site. When the liner was attached as part of the installation step, the disposal step further includes hoisting the liner out of the container prior to the removing and folding step. The disposal step also includes a liquid removal step, provided there is liquid within the container. The liquid removal step is utilized prior to the removing and folding step. The liquid removal step includes evaporating the liquid out of the container. The liquid removal step alternatively, in other exemplary embodiments, includes removing the liquid with a pump to a disposal site. In another preferred embodiment, the liquid removal step includes attaching straps provided on the container to a conventional hoisting mechanism, removing the support structure or framework and then lifting and transporting the entire container via the straps provided on the container.

Numerous concrete washout contaminate systems shall be set up directly next to each other for larger disposal needs or can be set up for instance along the length of a freeway for multiple washout areas. Because of the affordability of such an invention operators will be more prone to set up more than adequate enough concrete washout contaminate systems to meet the need and therefore keeping our clear waterways clean and environmentally safe.

In accordance with the various embodiments of the devices and methods of the present invention, advantages are achieved over conventional containment systems, such as the hay bales and the metal container. Some of these advantages of the present invention include: quick and easy installation of a containment device in minutes and an installation that is not labor intensive; providing a cost effective containment device; portability of a containment device with the ability to store the container behind the seat of a concrete truck or any variation thereof; ease of a washout method design requiring the operator and truck to stay firmly on the ground; prevention of leaks through the vinyl container; and ease of disposal of the materials captured by the container. The present invention provides various embodiments of portable containment devices that are environmentally friendly and convenient to use.

The present invention provides containment devices that can be utilized in a variety of applications as mentioned herein, such as being used as a concrete washout. However, it should be appreciated that reference to the concrete washout application should not be construed to limit the application of any of the embodiments of the methods or devices of the present invention. For example, a containment device made in accordance with the present invention could also be used for the purpose of washing out paint. This may allow for a smaller container of the same design, just a scaled down model. Painting contractors and homeowners will gain the ability to contain the excess paint in this washout and avoid contaminating the ground and clear water ways.

Another exemplary use of a containment device made in accordance with the present invention is for the purpose of oil disposal by mechanics or oil changes. This also may allow for a smaller container of the same design, just a scaled down model. The invention in this instance would be used as a temporary holding device as the contaminated liquid of this sort will not evaporate and must ultimately be poured into a large holding tank designed to hold contaminated oil. This invention does however provide a portability of containment to allow operators such as roadside assistance, farmers, homeowners and expanding oil lube bays without multiple drainage facilities and any variation thereof from spilling contaminated oil onto the ground.

Still further, a containment device made in accordance with the present invention could be utilized by fire fighters as a portable and temporary water storage in hard to reach locations.

The purpose of the some of the uses of the devices and methods of this invention includes compliance governmental regulations concerning the environment and proper disposal of contaminated liquid and materials.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes and combinations thereof may be made without departing from the spirit and scope of this invention.

What is claimed is:

1. A containment device comprising:
a support structure; and,
a container being flexible and removably attached to the support structure, the container having a cavity defined by a base and a wall, and the container having a top perimeter defined by the wall and a bottom perimeter defined by the base, wherein the dimension of the top perimeter is less than the bottom perimeter, and wherein the support structure is substantially disposed within the cavity.

2. A portable containment device as recited in claim 1, wherein the support structure includes a plurality of support members removably attached to at least one of another of the plurality of members.

3. A portable containment device as recited in claim 1, wherein:
the support structure includes a plurality of interconnected first and second supports;
the container includes at least one sleeve disposed along the top perimeter, wherein the first supports are disposed within the cavity and the second supports engage the container and extend through the at least one sleeve.

4. A portable containment device as recited in claim 3, further comprising a chute disposed on the wall and a drain disposed in the wall, and wherein the support structure includes a base support disposed at an end of at least one of the first supports.

5. A portable containment device as recited in claim 1, wherein the container includes a plurality of interconnected walls and each of the plurality of interconnected walls is non vertical.

6. A portable containment device as recited in claim 1, wherein the container includes at least two straps disposed on a side of the base opposite the cavity.

7. A portable containment device as recited in claim 1, further comprising a cover being removably attached to the support structure and operably configured to cover the cavity when in use.

8. A portable containment device as recited in claim 1, further comprising a filter removably attached to the support structure and at least partially disposed within the cavity of the container.

9. A portable containment device as recited in claim 8, wherein the filter includes a filter top perimeter and plurality of straps disposed adjacent to the liner top perimeter.

10. A containment device comprising:
a framework having a plurality of horizontal poles and a plurality of vertical poles, each of the vertical poles being connected to at least two of the plurality of the horizontal poles; and,
a container being flexible and having a base and at least one wall, the base being connected to a bottom edge of each of the at least one wall and the at least one wall defining a cavity of the container, wherein the cavity has a top perimeter and at least one sleeve disposed along the top perimeter and wherein at least one of the horizontal poles of the framework is disposed within the at least one sleeve and the vertical poles of the framework are disposed within the cavity.

11. A containment device as recited in claim 10, wherein the connection between the plurality of vertical poles and horizontal poles includes a removable connection.

12. A containment device as recited in claim 10, wherein the at least one wall is disposed at an angle of less than 90 degrees relative to the interior bottom of the cavity.

13. A containment device as recited in claim 10, wherein the container includes at least two straps disposed on opposing sides of the container.

14. A containment device as recited in claim 10, wherein the at least one wall and the base are integral and further comprising a chute disposed on the at least one wall and a drain disposed in the at least one wall.

15. A containment device as recited in claim 10, further comprising a cover being removably attached to the framework and operably configured to cover the cavity when in use.

16. A containment device as recited in claim 10, further comprising a liner removably attached to the framework and at least partially disposed within the cavity of the container.

17. A containment device as recited in claim 16, wherein the liner includes a liquid permeable mesh.

18. A containment device as recited in claim 16, wherein the liner includes a liner top perimeter and plurality of straps disposed adjacent to the liner top perimeter.

19. A containment washout method comprising:
an installation step including assembling a support structure and securing a flexible container having walls to the support structure with the support structure being substantially disposed within the container and with the walls being attached to the support structure in a non-vertical alignment;
a washout step includes orienting an equipment device to be washed out with and over one of the walls of the container and washing the equipment with a liquid such that the liquid and material being washed out of the equipment fall in the container; and,
a disposal step includes removing the support structure and collapsing up the walls of the container.

20. The method as recited in claim 19, wherein:
the installation step includes attaching a filter to the support structure such that the filter is substantially disposed within the container; and,
the disposal step includes hoisting the filter from the container.
